(19) United States
(12) Patent Application Publication
(10) Pub. No.: US 2012/0019700 A1
(43) Pub. Date: Jan. 26, 2012

(54) Optical system with automatic mixing of daylight and thermal vision digital video signals

(75) Inventor: Leonid Gaber, San Leandro, CA (US)

(73) Assignee: American Technologies Network Corporation

(21) Appl. No.: 12/804,591

(22) Filed: Jul. 26, 2010

(51) Int. Cl. H04N 5/335

(52) U.S. Cl. 348/311; 348/E09.01

(57) ABSTRACT

An optical sight system that comprises a combination of a thermal scope with a CCD visible-range attachment connectable to the thermal scope with a quick-release connector. The system is equipped with a device for automatic interposition of the digital visible image of the CCD visible-range attachment onto the digital thermographic image when the attachment is electrically and mechanically connected to the thermal scope. The CCD is a light-weight device which does not have screen and which is easily attached to the thermal scope by means of a quick-release connection unit. Both digital images are observed on the screen of the thermal-scope display.

### FIELD OF THE INVENTION

The present invention relates to an optical system that comprises a charge coupled camera (CCD) camera and a thermal scope. More specifically, the invention relates to an optical sight system composed of a thermal scope and a CCD visible-range attachment with automatic mixing of daylight and thermovision digital visual signals for overlapping the digital daylight and thermal vision images on the screen of the CCD camera display. display The optical sight system of the invention is intended for use on a firearm weapon as well as on spotting scopes, binoculars, etc.

### BACKGROUND OF THE INVENTION

Known in the art is a great variety of optical sights, which, according to one variety of classifications, is categorized according to three ranges of operational wavelength: (1) day-vision optical sights; (2) night-vision optical sights; and (3) thermal-vision sights. Daylight optical sights operate in the wavelength range of 400 nm to 700 nm. Night-vision optical sights operate in the wavelength range of near infrared light to 1.7 nm. Thermal-vision sights operate in the middle infrared wavelength range to 13 μm.

Typically, daylight optical sights are used with firearms such as guns or rifles to allow the user to more clearly see a target. Conventional optical sights include a series of lenses that magnify an image and are provided with a reticle that allows the user to align the magnified target relative to the barrel of the firearm. Proper alignment of the optical sight with the barrel of the firearm allows the user to align the barrel of the firearm and, thus, to align the projectile fired therefrom with the target by properly aligning a magnified image of the target with the reticle pattern of the optical sight. A great variety of various modifications exists for day-vision optical sights, such as sights with reticle illumination, red-dot sights, etc.

An example of a conventional day-vision optical sight is disclosed in U.S. Pat. No. 7,411,750 issued on Aug. 12, 2008 to S. Pai. The optical sight includes an outer barrel having opposite ends; ocular and objective lens units mounted respectively to the ends of the outer barrel; a magnification unit disposed tiltably in the outer barrel and extending between the ocular and objective lens units; an adjustment unit mounted on the outer barrel that operates independently and respectively to adjust the position of the magnification unit inside the outer barrel in first and second directions that are perpendicular to each other.

A typical night-vision sight uses an objective lens having a maximized size for maximum light-gathering capability. After passing through the objective lens, light passes through a focusing assembly that is used to vary the distance of light traveling between lenses within the sight by moving either the focal-length adjustment lens, with respect to the objective lens, or a mirror within the night-vision device along the axis that changes the length of the light path. The light is therefore brought into sharp focus on the photosensitive surface of the image intensifier. In a night-vision sight, a photocathode having electrical current flowing therethrough, which forms the photosensitive surface of the image intensifier, converts the optical image into an electronic image that is transmitted through an electron flow. The electrons are accelerated through the image intensifier and remain focused because of the proximity of surfaces within the image-intensifier tube. Acceleration of electrons, combined with a microchannel electron-multiplying plate, results in intensification of the original image. When the electrons reach the screen, the electronic image is converted to an optical image. The final, amplified visible image is displayed to the user or to other optical devices within the night sight.

An example of a night-vision sight is disclosed in U.S. Pat. No. 6,456,497 issued on Sep. 24, 2002 to G. Palmer. This patent describes a night-vision binocular assembly that includes at least one objective lens assembly, an image-intensifier tube, a collimator lens assembly, and a diopter cell assembly encased in easy-to-assemble waterproof housing. The objective lens assembly, image-intensifier tube, collimator lens assembly, and diopter cell assembly are supported by a common base structure within the housing. The device is provided with button controls to operate and adjust the night-vision binocular assembly. The button controls are placed on a common circuit board, which is affixed to the interior of the binocular housing.

Known in the art is a night-vision sight, which is installed on the soldier's helmet and which, for convenience of use under combat conditions and for preventing operation of a light source when the sight is not in use, is provided with automatic switching, depending on the position of the sight on the helmet. Such a device is disclosed, e.g., in U.S. Pat. No. 6,087,660 issued on Jul. 11, 2000 to T. Morris, et al. The night-vision device includes a control circuit having an acceleration-responsive switch. When the night-vision device is in the horizontal position, the acceleration-responsive switch enables a circuit that allows the voltage to be applied to an image-intensifier tube of the night-vision device so that night vision is provided. On the other hand, when the device is flipped up to a stowed position on the helmet, which allows the user of the device unobstructed natural vision, the acceleration-responsive switch senses the changed orientation of the gravitational acceleration vector and turns off the image-intensifier tube as well as other light-emitting sources of the night-vision device. The acceleration-responsive switch controls operation of the voltage step-up circuit, which allows the night-vision device to operate with a single one-and-one-half-volt battery cell, and which also ensures when it is turned off that not only is the image-intensifier tube turned off but also that all other possible sources of light emissions from the night-vision device are turned off.

There exist a variety of image-fusion optical sights in which various modes of image reproduction are used in combination simultaneously or alternatively.

For example, U.S. Patent Application Publication 2007/0035824 published Feb. 15, 2007 (inventor: R. Scholtz) discloses a sighted device operable in visible-wavelength or electro-optical/visible-wavelength sighting modes. The device has a sight that includes an objective lens lying on the optical axis of the sight so that an input beam is coincident with the optical axis; an eyepiece lens lying on the optical axis; an imaging detector having a detector output signal; a signal processor that receives the detector output signal from the imaging detector, modifies the detector output signal, and has a processor output signal; and a video display projector that receives the processor output signal and has a video display projector output. An optical beam splitter lies on the optical axis. The beam splitter allows a first split subbeam of the input beam to pass to the eyepiece lens and reflects a second split subbeam of the input beam to the imaging detector. An optical mixer mixes the first split subbeam and the video display projector output before the first split subbeam passes through the eyepiece lens. According to one aspect of the invention disclosed in U.S. Patent Application Publication 2007/0035824, the imaging detector of the sight may include a silicon charge-coupled device (CCD), a complementary metal oxide semiconductor (CMOS), an intensifier fiber coupled to a CCD, and an InGaAs array. The imaging detector may be located at the objective primary focus.

Another example of a switchable optical sight is a self-contained day/night optical sight disclosed in U.S. Pat. No. 6,608,298 issued on Aug. 19, 2003 to L. Gaber. The device has a sealed sight housing permanently attached to the weapon or to another object and containing an objective lens and an eyepiece lens installed on a common optical path at a distance from each other so that a space is formed between both. The same sealed housing pivotally supports a night-vision unit, such as an image-intensifier tube, which can be turned in the plane that contains the optical axis of the sight between the position offset from the aforementioned common optical axis and the position coincident with the optical axis. Since both night-vision and day-vision optics are located in a sealed housing, the lenses are protected from contamination and fogging. The use of a single optical path makes it possible to reduce the weight of the system. Rotation of the night-vision unit to the working position is interlocked with the day-vision optics so that switching of the sight to night-vision conditions automatically shifts the daytime optics back for the distance required for matching both optics.

A relatively new trend in the field of optical sight is the use of night-vision sights operating on the principle of thermal vision. Such devices are commercially produced, e.g., by Irvine Sensors Corporation (e.g., Miniaturized Low Power Thermal Viewers and Miniature Thermal Imager, Models MTI 3500 320×240 and MTI 6000 640×480).

Another new trend in the field of optical sights is the use of sights with images of targets reproduced by image fusion. In computer vision, multisensor image fusion is defined as the process of combining relevant information from two or more images into a single image. The resulting image is more informative than any of the input images.

An example of a fused thermal and night scope is disclosed in U.S. Pat. No. 7,319,557 issued on Jan. 15, 2008 to A. Tai. The device includes an optical gun sight, a thermal sight, and a beam combiner. The optical sight generates a direct-view image of an aiming point or reticle superimposed on a target scene. The thermal sight generates a monochromic thermal image of the target scene. The combiner is positioned behind the 1× nonmagnified optical sight and the thermal sight and in front of the exit pupil of the thermal sight. The combiner is positioned directly behind the intermediate image plane of the magnified optical sight between the objective lens and the eyepiece. The combiner passes the direct-view image and reflects the thermal image to the exit pupil to fuse the thermal image onto the direct-view image for viewing by the user at the exit pupil as a combined thermal and direct-view optical image of the target scene together with the aiming reticle.

However, the optical gun sight projects onto the common screen of the display device a direct optical day-light image onto which a thermogram of the thermal sight is imposed. It is understood that the device, which in this publication is called a beam combiner, cannot function as an image mixer. This is because under a day-light condition the thermogram cannot present a meaningful image, while at the night time a daylight image cannot be reproduced. Therefore, a viewer will see essentially either a day-light image or a thermogram.

### SUMMARY OF THE INVENTION

An optical sight system is characterized by automatic mixing of daylight visual digital image with a digital thermogram produced by a thermal scope at any time of the day irrespective of illumination conditions, which is especially important at dusk and early in the morning, or at intensive moon light at night. The system consists of a thermal scope and a CCD visible-range attachment with automatic mixing of a daylight visual digital image with night-time digital thermogram. The thermal scope contains its own optical system, a microbolometric array, and a display. Other elements of the system are a disconnectable CCD visible-range attachment, e.g., a part of a CCD visible-range camera attachable to the thermal scope by means of a quick-release connection and operating in conjunction with the display of the thermal scope. The CCD visible-range attachment is also provided with a signal control unit and a digital mode mixer control unit.

The thermal scope is provided with an input that is intended for electrical connection with the output of the CCD visible-range attachment through an electric cable when the CCD visible-range attachment is attached to the thermal scope by the quick-release connection unit. The thermal scope output is connected directly with the input of the display.

The thermal scope operates on the principle of thermal video, detects radiation in the infrared range of the electromagnetic spectrum (7 μm to 13 μm), and produces images of that radiation, referred to as the aforemenitoned thermograms. Since infrared radiation is emitted by all objects near room temperature, according to the black-body radiation law, thermography makes it possible to see one's environment with or without visible illumination. The amount of radiation emitted by an object increases with temperature; therefore, thermography allows one to see variations in temperature. When viewed through the display of the thermal scope, warm targets are seen brighter than cooler backgrounds. At night time, humans and other warm-blooded animals become easily visible against the environment. As a result, thermography is particularly useful to the military and to security services.

The thermal scope has an uncooled microbolometric array in the form of focal plane array (FPA) sensors located in the thermal image plane. The thermal image is reproduced in the image plane by means of a special germanium-optic lens with high transparency for irradiation in the wavelength range of 7 to 13 μm. The microbolometric array is connected to a video fader control unit, which is connected to a digital display of the thermal scope through an adder. an addercollecting, processing, and transmitting to the display. A mid-infrared radiation-receiving element of the microbolometric array comprises a matrix of microbolometers that provides resolution, e.g., of 320×240 pixels. This resolution is given only as an example.

The CCD visible-range attachment comprises a self-contained unit that can be stored separately from the thermal scope (e.g., in a soldier's pocket, if it is used in connection with a military-sight thermal scope). The attachment has small dimensions and is light in weight (less than 0.5 kg). The attachment contains it own optics of the type used in conventional camcorders with optical characteristics (focal length, field of view, etc.) similar to those of the thermal scope lens but operating in the visible range of wavelengths from UV to near-IR. The aforementioned optics forms a digital image by means of a CCD array. The CCD visible-range attachment may not to have a display and is intended for displaying a daylight digital digital image on the display of the thermal scope. The CCD visible-range attachment is provided with its own video fader control unit. The CCD attachment is also provided with a mode mixer. When the CCD attachment is attached to the thermal scope by means of a quick-release connector, and the electrical connection is established between the CCD attachment and the thermal scope, the video fader control unit of the CCD attachment is electrically connected to the video fader control unit of the thermal scope via the mode mixer of the CCD attachment. The function of the mode mixer is to level the digital video signals produced by the CCD attachment and the thermal scope. The leveled digital video signals of the CCD attachment and of the thermal scope are processed in an adder and are sent to the thermal-scope display.

Thus, when the CCD visible-range attachment is connected, and the thermal scope is on, the thermal scope display will always reproduce a mixed digital image composed of a visual CCD image and a thermographic image of the night scope.

Such constant reproduction of both daylight visual digital image and the thermographic night image on the common screen of the thermal-scope display is especially important for combat conditions when a soldier may not have time to manually switch observation conditions.

The mixing level can be preliminarily set by means of the mode mixer. For example, the mixer mode can be set for prevailing of the daylight visual digital image with alleviation of the digital thermographic image, or vice verse.

Since the CCD attachment is small and lightweight, it can be disconnected from the thermal scope and stored in a convenient location, e.g., in a pocket. In that case the thermal scope operates in its conventional night-vision mode. When necessary, the CCD attachment can be momentarily attached to the thermal scope through the quick-release connection unit, and the device will operate with automatic mixing of the daylight visual mode and night thermal-vision mode, irrespective of the target illumination conditions.

### BRIEF DESCRIPTION OF THE DRAWINGS

FIG. 1 is a three-dimensional view of the optical sight system that comprises a thermal scope and a CCD visible-range attachment with automatic mixing of the daylight and thermal vision operation modes.

FIG. 2 is a block-diagram of the system of FIG. 1.

### DETAILED DESCRIPTION OF THE INVENTION

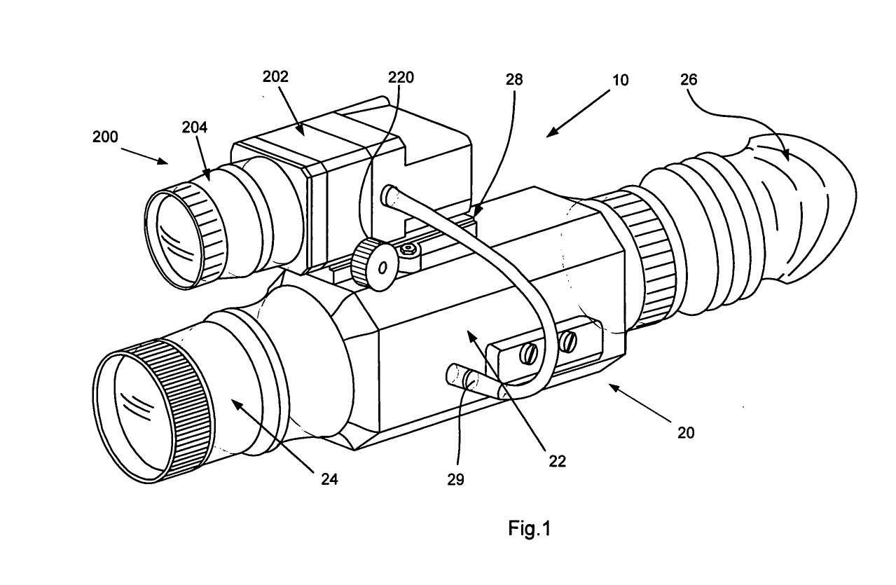

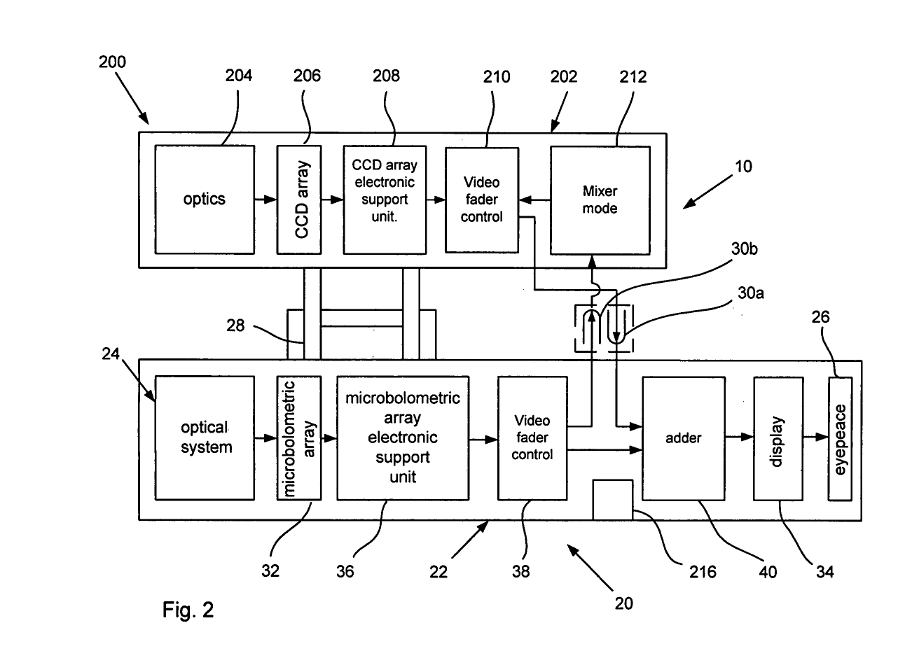

A general three-dimensional view of an optical sight system that comprises a thermal scope and a CCD visible-range attachment is shown in FIG. 1, and a block diagram of the system is shown in FIG. 2. As shown in the drawings, the system, which as a whole is designated by reference numeral 10, comprises a thermal scope 20 and a CCD visible-range attachment 200 with automatic mixing of the daylight and night thermographic operation modes. Although in the illustrated example the system 10 composed of the thermal scope 20 and a CCD visible-range attachment 200 is shown as an optical sight, other applications such as spotting scopes, binoculars, or the like, are also possible. In other words, the specific example of the optical sight is further described only for illustrative purposes.

The main part of the system 10 is a thermal scope 20, which may comprise a conventional optical-sight type of thermal scope that operates in the wavelength range from 7 to 13.5 μm. In general, thermal scopes of such type can be exemplified by an ATN ThOR 2 device produced by ATN Corp. The ATN ThOR 2 Thermal Optical Riflescope combines the ergonomic features of a handheld device and the convenience of a weapon mounting based on the proven 320×240 microbolometer core. The device is characterized by high-resolution digital thermal imaging. It is compact, lightweight, has a durable housing, can be operational in 3 seconds, and can operate for 6 or more hours with four lithium batteries. The ATN ThOR 2 thermal scope has the following main characteristics: optical system magnification 2× (digital 4×); field of view: 12°×9°; an uncooled microbolometer; spectral response: 7-13 μm; thermal sensitivity: 50 mK; range to detect a live object: 900 m; dimensions (without bracket): 215×77×83 mm; and weight (with batteries): 0.94 kg.

The thermal scope 20 operates on the principle of thermal video, detects radiation in the infrared range of the electromagnetic spectrum (roughly 7 μm to 13 μm), and produces images of that radiation, called thermograms. Since infrared radiation is emitted by all objects near room temperature, according to the black-body radiation law, thermography makes it possible to see one's environment with or without visible illumination. The amount of radiation emitted by an object increases with temperature; therefore, thermography allows one to see variations in temperature. When viewed through the display of the thermal scope 20, warm targets (not shown) are seen brighter than cooler backgrounds. At night time, humans and other warm-blooded animals become easily visible against the environment. As a result, thermography is particularly useful to the military and to security services. The appearance and operation of the thermal scope 20 is similar to a day/night optical scope. The CCD and CMOS sensors used for visible-light cameras are sensitive only to the nonthermal part of the infrared spectrum (NIR). Thermal imaging cameras use specialized focal plane arrays (FPAs) that respond to longer wavelengths (mid- and long-wavelength infrared). The most common types are InSb, InGaAs, HgCdTe, and QWIP FPA. However, sensor arrays of the aforementioned type require special means for cooling.

The optical system 24 of the thermal scope 20 may reproduce a thermographic image in the image plane by means of special germanium lens optics with high transparency for irradiation in the wavelength range of 7 to 13 μm.

As can be seen in FIG. 1, which shows the external parts of the thermal scope 20, the latter contains a housing 22 that incorporates internal parts, which are shown in FIG. 2 and are described below, a thermal scope optical system 24 supported by the front end of the housing 22, and an eyepiece 26 supported by the rear end of the housing 22. The upper side of the housing 22 is provided with a quick-release connection unit 28. This unit may be of any type known in the art for connection of various attachments, e.g., one used on conventional day- or night-vision optical sights. An example of a quick-release connection unit is an ATN Quick Release Mount produced by ATN Corp. The device has dual locking levers and a weaver mounting system.

In fact, some commercial thermal scopes are provided with video output and video input. The thermal scope 20 is also provided with a thermal cope video input 30a and a thermal scope video output 30b (FIG. 2), the purpose of which is explained later in connection with the respective parts of the CCD visible-range attachment 200.

Inside the housing, the thermal scope 20 contains a thermal scope microbolometric array 32, which is linked on one side to the thermal scope optical system 24 and on the other side with a display 34 through a micorobolometric array electronic support unit 36 of the thermal scope, a thermal scope video fader control unit 38, and an adder 40. Furthermore, the thermal scope video fader control unit 38 is electrically connected to the aforementioned thermal scope video output 30b of the thermal scope 20.

The thermal scope optical system 24, the thermal scope microbolometric array 32, and the microbolometric array electronic support unit 36 together form a thermal-vision digital signal generation unit that generates the aforementioned thermal digital video signal.

As mentioned above and shown in the illustrated embodiment, the thermal scope microbolometric array 32 can be of an uncooled type and is made in the form of FPA (matrix) sensors located in the thermal-image plane. The display 34 may comprise a conventional camcorder type of display for observation of the field of view with the eyepiece 26.

The CCD visible-range attachment 200 comprises a self-contained unit that can be stored separately from the thermal scope 20 (e.g., in a soldier's pocket, if it is used in connection with a military-sight thermal scope). The attachment 200 is small and weighs less than 0.5 kg. As mentioned above, the CCD visible-range attachment 26 does not have a display and is intended for displaying a daylight visual digital image on the display 24 of the thermal scope 22.

The CCD visible-range attachment 200 is connected to the thermal scope 20 through the quick-release connection unit 28. The electrical connection is carried out through a cable 29 shown in FIG. 1. For adjusting the position of the optical axis of the CCD visible-range attachment 200, the connection unit may be equipped with a conventional windage and elevation mechanism 220 (FIG. 1) of the type described, e.g., in U.S. Patent Application Publication 2010077646 published in 2010 (inventor L. Gaber, et al).

The CCD visible-range attachment 200 may comprise a part of a small CCD visible-range camera but without a display. The CCD visible-range attachment 200 has a CCD attachment housing 202, the front end of which supports a CCD attachment optical system 204 of the type used in conventional camcoders with optical characteristics (focal length, field of view, etc.) similar to those of the thermal scope optics 24 but operating in the visible range of wavelengths from UV to near-IR. The aforementioned optics forms an image by means of a CCD array 206. The CCD array 206 is connected to a CCD array electronic support unit 208. When the CCD visible-range attachment 200 is attached to the thermal scope 24, the CCD array electronic support unit 208 is electrically connected to the display 34 of the thermal scope 20 through a CCD video fader control unit 210 that is installed in the housing 202 of the CCD visible-range attachment 200 (FIG. 2) and is provided with a video output connectable via the cable 29 (FIG. 1) with the video input 30a of the thermal scope 20. The video fader control unit 210, in turn, is connected to a mode mixer control unit 212, which also is connected with a video output 30b of the thermal scope 20.

When the CCD visible-range attachment 200 is attached to the thermal scope 20, the video fader control unit 210 of the CCD visible-range attachment 200 is electrically connectable to the added 40 of the thermal scope 20, and the video fader control unit 38 of the thermal scope 20 is connectable to the mode mixer control unit 212 of the CCD visible-range attachment 200.

The CCD attachment optical system 204, CCD array 206, and CCD array electronic support unit 208 together form a CCD visible-range digital signal generation unit that generates a preliminary digital video signal from the CCD visible-range attachment 200.

Reference numeral 216 shows a master switch, which is connected to power supply units (not shown) of the thermal scope 20 and of the CCD visible-range attachments 200. When necessary, e.g., for storage, transportation, or repair, the main switch 214 can deactivate the entire system 10.

The system 10 operates as described below.

When the CCD visible-range attachment 200 is connected to the thermal scope 20 through the quick-release connection unit 28 and the cable 29, which connects the output of the CCD visible-range attachment 200 with the video input 30a/output 30b of the thermal scope 20, and if the thermal scope is activated by means of the master switch 216, the CCD visible-range attachment 200 is automatically electrically activated.

During operation, the optical system 24, the microbalometric array 32, and the microbalometric array electronic support unit 36 of the thermal scope 20 form a thermal scope digital video signal, which is supplied to the thermal scope video fader control unit 38. The thermal scope digital video signal processed in the thermal scope video fader control unit 38 is fed to the adder 40 and at the same time to the digital mode mixer control unit 212 of the CCD visible-range attachment 200.

Meanwhile, the CCD attachment optical system 204, CCD array 206, and CCD array electronic support unit 208 of the CCD visible-range attachment 200 generate a preliminary digital video signal, which is supplied to the CCD video fader control unit 210. This digital signal is processed in the CCD video fader control unit 210, and the processed digital signal is supplied to the adder 40 of the thermal scope 20 via the video input 30a of the thermal scope 20.

The mode mixer control unit 212 carries out leveling of the digital video signal obtained from the video fader control unit 210 with the digital video signal obtained from the video fader control unit 38 of the thermal scope 20. Thus, the adder receives two matched digital video signals, i.e., one from the CCD visible-range attachment 200 and another from the thermal scope 20. As a result, a viewer can see on the screen of the thermal scope display 34 the image of the CCD visible-range attachment 200 implied onto the thermographic image.

Since the CCD visible-range attachment 200 has small dimensions and is lightweight, it can be disconnected from the thermal scope 20 and stored in a convenient location, e.g., in a pocket. When necessary, the CCD visible-range attachment 200 can be removed from a pocket or other easy-to-reach place and momentarily attached to the thermal scope 20 through the quick-release connection unit 28.

The position of the visual image of the CCD visible-range attachment 200 on the screen of the display 34 can be adjusted with use of the windage and elevation mechanism 220.

When the CCD visible-range attachment 200 is disconnected, the thermal scope 20 operates only in the thermogram-obtaining mode.

Although the invention is shown and described with reference to a specific embodiment, it is understood that any changes and modifications are possible within the scope of the attached patent claims. For example, the optical system with automatic interposition of a daylight visual mode image onto the image produced by the thermal scope applies not only to military optical sights but to other optical devices such as photographic cameras, medical diagnostic instruments, etc. The system may incorporate thermovisors and CCD camcorders of different models. CCD daylight visual attachments are not necessarily devices without display and may comprise conventional, commercially produced camcorders of small dimensions. The electrical connection of the CCD attachment to the thermal scope can be incorporated into the quick-release connection unit for simultaneous electrical and mechanical connection between both devices.

1. An optical system with automatic mixing of a daylight visual digital image and a digital thermographic image comprising:
a thermal scope that comprises a display, a thermal-vision digital signal generation unit that generates a thermal scope digital video signal and that is connected to the display for reproduction of the digital thermographic image, a thermal scope input and a thermal scope output; a connection unit for attachment of the CCD visual-range attachment to the thermal scope; and
CCD visible-range attachment that comprises a CCD visible-range digital signal generation unit that generates a preliminary digital video signal, a CCD video fader control unit, and a mode mixer control unit connectable to the display, the thermal vision digital signal generation unit and the CCD visible-range signal generation unit being connectable to the display of the thermal scope through the thermal scope input and a thermal scope output.

2. The optical system of claim 1, wherein the thermal-vision digital signal generation unit that generates the thermal scope digital video signal comprises a thermal scope optical system, a thermal scope microbolometric array, and a microbolometric array electronic support unit of the thermal scope, wherein the thermal scope optical system is connected to the thermal scope microbolometric array electronic support unit through the thermal scope microboloscopic array, and wherein thermal scope microbolometric array electronic support unit is connected to the display for transmitting the thermal scope digital video signal.

3. The optical system of claim 1, wherein the CCD visible-range digital signal generation unit comprises a CCD attachment optical system, a CCD array, and a CCD array electronic support unit, wherein the CCD attachment optical system is connected to the CCD array electronic support unit through the CCD array, and wherein the CCD array electronic support unit is connected to the mode mixer control unit through the CCD video fader control unit.

4. The optical system of claim 2, wherein the CCD visible-range digital signal generation unit comprises a CCD attachment optical system, a CCD array, and a CCD array electronic support unit, wherein the CCD attachment optical system is connected to the CCD array electronic support unit through the CCD array, and wherein the CCD array electronic support unit is connected to the mode mixer control unit through the CCD video fader control unit.

5. The optical sight system of claim 1, wherein the CCD visible-range attachment comprises a CCD visible-range camera without a display.

6. The optical sight system of claim 2, wherein the CCD visible-range attachment comprises a CCD visible-range camera without a display.

7. The optical sight system of claim 3, wherein the CCD visible-range attachment comprises a CCD visible-range camera without a display.

8. The optical sight system of claim 4, wherein the CCD visible-range attachment comprises a CCD visible-range camera without a display.

9. The optical sight of claim 5, wherein the connection unit is a quick-release type connection unit.

10. The optical sight of claim 6, wherein the connection unit is a quick-release type connection unit.

11. The optical sight of claim 7, wherein the connection unit is a quick-release type connection unit.

12. The optical sight of claim 8, wherein the connection unit is a quick-release type connection unit.

13. The optical sight of claim 1, wherein the system is further provided with an electric cable for connecting the thermal scope video fader control unit with the mode mixer control unit through the thermal scope output and for connecting the CCD video fader control unit with the adder of the thermal scope via the thermal scope output when the CCD visible-range attachment is connected to the thermal scope by means of the connection unit.

14. The optical sight of claim 4, wherein the system is further provided with an electric cable for connecting the thermal scope video fader control unit with the mode mixer control unit through the thermal scope output and for connecting the CCD video fader control unit with the adder of the thermal scope via the thermal scope output when the CCD visible-range attachment is connected to the thermal scope by means of the connection unit.

15. The optical sight of claim 6, wherein the system is further provided with an electric cable for connecting the thermal scope video fader control unit with the mode mixer control unit through the thermal scope output and for connecting the CCD video fader control unit with the adder of the thermal scope via the thermal scope output when the CCD visible-range attachment is connected to the thermal scope by means of the connection unit.

16. The system of claim 1, wherein the CCD attachment optical system has an optical axis, and the connector unit is a quick-release connector unit, the system further comprising a windage and elevation adjustment mechanism for adjusting the position of the optical axis of the CCD visible-range attachment.

17. The system of claim 14, wherein the CCD attachment optical system has an optical axis and the system further comprises a windage and elevation adjustment mechanism for adjusting the position of the optical axis of the CCD visible-range attachment.

18. The system of claim 16, wherein the CCD attachment optical system has an optical axis and the system further comprises a windage and elevation adjustment mechanism for adjusting the position of the optical axis of the CCD visible-range attachment.

19. The system of claim 17, wherein the connection unit is a quick-release connection unit.

20. The system of claim 18, wherein the connection unit is a quick-release connection unit.
